(19) United States
(12) Patent Application Publication
(10) Pub. No.: US 2011/0295732 A1
(43) Pub. Date: Dec. 1, 2011

(54) System and method of ascertaining market value of an asset, liability, or other article, through a competitive valuation process

(76) Inventor: Jeffery Dustin Josephsen, Bellevue, WA (US)

(21) Appl. No.: 12/789,407

(22) Filed: May 27, 2010

(51) Int. Cl. G06Q 40/00

(52) U.S. Cl. 705/35

(57) ABSTRACT

System and method are provided for analyzing the value of an asset, liability, or other article. Generally, this is done by the relationship between two processes. The first process is of gathering and averaging valuation estimates from multiple independent sources. The second process is that of compensating the providers of those estimates according to the proximity of their valuation to the median or average of those estimates. The compensation motivates the providers of valuations, known here as Evaluators, to compete in giving valuations which will be closer to the average or median than other valuations, and they will find that this is accomplished by competing to be more accurate than their competitors. These systems, when working together, find synergy in creating an altogether more accurate system of valuing assets, liabilities, or other articles that may need to be valued, than that of tradition, computerized, or prior art methods.

### RELATED U.S. PATENT DOCUMENTS

Not Applicable

### ENTITY

Small Entity Concern

### FEDERALLY SPONSORED RESEARCH

Not Applicable

### DESCRIPTION OF ATTACHED APPENDIX

Not Applicable

### BACKGROUND OF THE INVENTION

I. Field of the Invention

This invention relates to systems and methods for performing valuations of assets, liabilities, or other articles, as claimed. More specifically, by introducing this method an opportunity for competition is created between different valuation methods. This method has the potential to become a standard method for diverse valuation methods in a diversity of industries.

II. Background Information

Currently, in the prior art and the market surrounding the valuation of assets such as businesses, intellectual property, and real estate; there exists a vacuum where some centralizing and clarifying tool could exist. There are many methods and systems for calculating the value of, say for example, a residential property, but when it comes to bringing these methods together in order to decide which is best to use, then often there is significant dissonance. This business method has the potential to remedy that situation significantly, and to bring together methods and systems of valuation in a diversity of markets. Background and prior art valuation methods of businesses, intellectual property, and real property will be addressed along with general statements of the need for this method in other industries.

II. A. Methods for Valuing Businesses

The value of a business entity is often based primarily on characteristics delineated by the GAAP or Generally Accepted Accounting Principles that take into account the expected cash flows and risk associated with the future of those cash flow. Occasionally, but generally and theoretically, other factors are also included such as potential strength in the market place, competitive advantages, and other strategic characteristics. Then lastly, there are characteristics which are almost never included, but can affect the value of the business and its cash flow a great deal. These other characteristics might include public good will or elasticity of employee morale.

Understandably, more touchy-feely or subjective characteristics are much less likely to be quantifiable in terms of the cash “value” of the business; however they are still very likely to affect the profit margin of the company. The current method lacks an appropriate avenue for the human side of subjective valuation. It is said better here: “Unfortunately, traditional accounting conventions and categories do not embrace the full range of value drivers implicit in a robust theory of [the value of] the firm. New ways of recording and reporting relevant data are needed to make a conceptual Holy Grail of business valuation useful to managers and investors” (Young 3).

The tendency for business valuation to include more subjective and diverse characteristics is being meted-out in the inclusion of other professionals in the valuation marketplace. “The majority of valuation professionals are non-CPSs—possessing CFAs, Finance Degrees, or MBAs . . . 90-95% of [business] valuation professional at the big five are non-CPA's” (Goldwasser 014). These other professionals are more strategically oriented to consider factors besides the GAAP factors, and they understand more broadly how the valuation is linked to business decisions. “Business decision making is driven, rightfully, by valuation analysis” (Young 1).

Some over-specific reporting expectations and legal liabilities are issues for Business Valuation Professionals. Some in the profession are warned away from accepting valuation engagements due to the exactitude and risk involved in these valuations, as stated here, “CPAs should only accept [business valuation] engagements that involve an acceptable degree of risk, taking into consideration the nature of the business to be valued and the extent and reliability of the information upon which the valuation will be based” (Goldwasser, 014).

It has become a general theme in the business valuation industry that a new and more centralizing valuation method is necessary in general and in sectors of new innovations where valuations would otherwise be hard to value and therefore finance. “Now is the time to create new means of financing innovation” (Jarboe 075).

These issues including the need to consider subjective and diverse means of valuing property, over-specific reporting expectations, legal liability issues, new hard-to-value business limitations, and the lack of a centralizing valuation method. These issues will be addressed significantly within the scope this new business method.

II. B. Methods for Valuing Intellectual Property

Intellectual property valuation, like business valuation, is lacking a standardized approach. “Why hasn't IP-backed financing made it into the financial mainstream? The answer is simple: many lenders and investors still do not feel comfortable with these assets. They question remains how the assets should be accurately valued and financially projected . . . Although many complex models serve to support valuation estimates in the market today, there is no one standard model of assessing intangibles” (Jarboe 075).

The valuation of innovation and intellectual property is of paramount importance to individual companies and the economy as a whole. Without an appropriate means to value intellectual property the funding of these innovations hits a bottleneck. This is the case in the economy today. “Many companies may be undervalued on Wall Street because research analysts do not factor the true value of intellectual assets into their assessment of these firms . . . because intellectual assets represent such a significant portion of a company's worth, and typically, intellectual property comprises the largest part of those intellectual assets” (Rose 036).

Even though it is the case that, “valuation is becoming more important in the area of intellectual property, especially in the technology sector” (Goldwasser 014). It is also the case that, “most companies have neither internal processes for identifying the most valuable patents in their portfolio nor an expertise in communicating the value of their IP to Wall Street” (Rose 036.

The funding bottleneck can be clearly seen in statements such as this, “It is not easy for investors to determine a market value for a company's patents or to model impact [on the market value, based] on revenues, sales, or margins. Lacking a universally accepted way of valuing patents or other intellectual property, the vast majority of investors ignore them, yet market value is driven by intangible assets and the market has know this for years” (Barney 008).

These issues including the IP funding bottleneck, sluggishness from a multiplicity of complex models, and the need for a centralizing and standard intellectual property valuation approach will be significantly addressed within the scope of this new business method.

II. C. Methods for Valuing Real Property

The trend of professional real property appraisers to overvalue properties due to undue influence from mortgage companies has become a major issue. “The [2007] suit [against Countrywide] further claims that outside appraisers who didn't come up with high home values were denied future work from the lender” (Palmeri 2). Also, the threat of legal liability is becoming more prevalent in the real property valuation marketplace, “In the past, appraisers seldom faced the threat of litigation. That is no longer the case . . . It is important that the appraiser remain mindful of the borrower or purchaser who might review a report at a later date looking for a basis for a lawsuit” (Appraisal Journal 110).

These issues are occurring to such a significant extent that a new set of rules, the HVCC (House Valuation Code of Conduct) has been set up to mandate more independence protection for the appraiser. “[The HVCC requirement] mandates the IVPI (Independent Value Protection Institute) promote best practices in the area of independent valuation” (Abernethy 89). To say that this HVCC has significant authority in the competitive mortgage industry would be an understatement. “Now national banks have a clear choice: immediately adopt the new code . . . or stop doing business with Fannie Mae or Freddie Mac” (Mortgage Banking 11). There are many in the real estate industry who feel the new rules are not improving the system in an effective or helpful way. Here are three examples:

“60% of Appraisers said the code was unlikely to change the quality of appraisals” (Palmeri 2).

“The Home Valuation Code of Conduct, which applies to loans purchased by Fannie Mae and Freddie Mac, was designed by regulators to protect appraisers from undue pressure by interested parties. Inflated appraisals got a fair share of blame for the housing crisis. But the fix has so many kinks that Congress is debating a moratorium on the new rules . . . . Costs have gone up $50-$75 per appraisal . . . real estate agents complain about appraisers who don't know the area . . . turnaround times are terrible. Plan on at least 30 days for an appraisal” (Kiplinger's Personal Finance 016).

“In a real estate world of seemingly endless downward spiraling housing prices, now emerges a staggering problem of sub-professional appraisals contributing to that decline . . . the appraiser took the path of least resistance, utilizing comparables that were the easiest to obtain, not necessarily the most accurate . . . for the appraisal system to work in the marketplace, the opinion maker has to be competent, and has to do their job” (London 39).

Oddly, in the same document put forth by Fannie Mae and Freddie Mac, the HVCC, the use of Automated Valuation Methods, AVMs, are supported to the extent that they have the same clout as a traditional formal appraisal, although they do not include a professional intuitive human-being in the appraisal process. Stated better, “The HVCC appears to worsen two problems. First, the code repeatedly equates the use of automated valuation models with prepared appraisals . . . by repeatedly and specifically pairing automated valuation models with appraisal reports it strongly signals that they are considered equivalent methods of property valuation . . . Second, the funding of a Value Protection Institute continues to be unclear” (Abernethy 90).

Furthermore, only the AVMs provided by Fannie Mae and Freddie Mac are considered valid. “Government sponsored enterprises, (GSEs), [Fannie Mae and Freddie Mac] have used their clout in incorporating AVMs into the underwriting process . . . that blessing applies only to AVMs offered by the GSEs themselves, to the exclusion of other vendors” (Nattagh 79).

This monopolization of the market place might be appropriate if the AVM methods were accurate, but studies have shown that they are not even remotely accurate. “Most commercially available [AVM] models [in 2005] estimate a property's market value within 10% of its benchmark value in roughly 75 percent of the cases. In other words, there is 25 percent probability that the estimated model values will be off by more than 10 percent” (Nattagh 73). “Zillow estimates overvalued property by 10% compared to the sales price . . . it appears less precise than a homeowners own estimate of home value” (Hollas 032).

Researchers of the method seem to feel strongly that AVMs methods have fundamental flaws which could affect the market as a whole, and represent a significant risk to our economy. “We see profound weaknesses in the approaches taken by lenders, vendors, and regulators to understand and apply this new [AVM] technology. This is particularly true in the areas of testing and implementation. In our view, the conventional process by which automated valuation model products are evaluated and compared is fundamentally flawed . . . a lack of understanding of probability theory” (Nattagh 70). “Increased usage [of AVMs] has given rise to concerns by investors and the regulatory agencies about the potential impact on the quality of loans underwritten [as much as 50% of originations] using valuation models” (Nattagh 72). Furthermore, “The lack of sophistication [in the AVM industry] is nowhere more apparent than in the current business practices involving model testing and validation and the quest for uniform industry standards” (Nattagh 73). Lastly, “It is unfortunate that the black-box marketing approach [of AVM vendors] has created an atmosphere of confusion and a sense of bewilderment among users. Overworked terminology and clichés such as ‘artificial intelligence’ or ‘neural network’ are often substituted for a more scientific explanation of AVM technology” (Mortgage Banking 079).

As a humorous side-note, consider this quote from a 1999 report which lauds the use of AVMs due to their low foreclosure rate, “The practice of accepting automated valuations that are ‘close [enough]’ stems largely from the extremely low [1999] mortgage default rate of 0.230/0.5” (Waller 287). This may also seem upsetting when considering the default rate of those same loans underwater in 2010.

Yet, there are those in the real property appraisal industry that point to the need for the subjective, intuitive human side of the equation, “No matter how much technological progress or new theory is developed, the skill of the individual appraiser in analyzing the property and its value elements will remain key to the credibility of the value conclusion” (Hanford, 170). Furthermore, “The [prior art of appraisal] software allows real estate professionals to accurately value commercial properties . . . [but] the marketplace doesn't always fit in a black box . . . they have to use their own intuitive judgment. And that's invaluable” (Rogers 024).

The amount of data which may be employed for real property valuations is growing yearly, but a centralizing method which would include a human factor in the system is lacking. “[for many years] the best appraisers were the ones with access to the best information . . . today, the Internet makes more market-related information available then anyone has time to analyze” (Hanford 169). Moreover, “The lack of data standards, or a truly standard source of data, contributes to spotty automated valuation method coverage and erratic performance” (Mortgage Banking 079).

In light of this backdrop, I would like to pursue another competitive approach. Some seem to think that it would be necessary to allow new and different theories in the valuation market place.

“The HVCC is not the appropriate response to concerns related to lender pressure on appraisers” (Abernethy 92).

“The world is changing faster than in any time in our history and many of the observed changes suggest the need for new theories applied to real estate valuation” (Hanford 169).

The state of real property valuations also known as appraisals or broker price opinions (BPOs), especially in residential real property, is currently an absolute mess. There is the rise of litigation issues for appraisers and mortgage brokers, there are new and failing rules for independent appraisals which mean to mitigate influences on appraisers, and there are new inaccurate automated methods which are destroying the wealth of homeowners and are unchecked by regulators. This new business method will significantly address each of those issues, and is absolutely necessary to compete with automated approaches.

II. D. General Statements Regarding Methods for Valuation

This business method could also be used in other market niches where a centralizing and motivating system is lacking. In the insurance industry for example, “There are too few incentives for agents and brokers to report adequate Insurance-to-Value [estimates]” (Insurance Advocate 030). Other niches where prior art exist, and this business method may be employed, include, but are not limited to: valuing collectibles or works of art, valuing liabilities for insurance purposes, estimate economic trends, valuing commodities, estimating project costs for the appropriate costs of big projects like bridges, schools, buildings, or other investments, and potentially valuing other items

The issues with the prior art are summarized as follows: the lack of a centralizing valuation method, the need to consider subjective means of valuing property, The new and inaccurate automated valuation methods, AVMs, the rise of litigation issues for appraisers and mortgage brokers, the continuing issue of undue influence on appraisers, the over-specific reporting expectations, growing legal liability issues, a multiplicity of disconnected complex models, and hard-to-value limitations on new types of new businesses which create an Intellectual Property and business funding bottleneck. Therefore, there is an unfulfilled need to have these issues addressed with a centralizing method as much as is possible. This business method aims to address those issues.

III. Objects and Advantages

Accordingly, besides the objects and advantages of the “Competitive Method of Valuation” Business Method described so far in this patent, several objects and advantages of the present business method are:
a) Gathering valuation opinions from multiple individuals allows for the advantages of
   a. A minimized undue influence on a single valuation professional
   b. A minimized litigation and concerns of litigation due to the objectivity of gaining multiple valuations
   c. A minimized reporting expectation as “opinions of multiple professionals” becomes the standard, as opposed to a preponderance and recordation of traditionally accepted valuation facts.
b) Compensating valuation professionals more greatly for being more accurate than their competitors allows for the advantages of:
   a. Better immediate accuracy as Evaluators will be motivated to be more accurate than their competitors
   b. Better reliability over multiple valuations, through the use of an “accuracy rating”, as the consistently more accurate evaluators are offered more work, and inaccurate Evaluators are filtered away.
c) Providing a centralizing valuation method allows for the advantages of:
   a. The potential to be a clearly understandable centralizing method for valuing assets
   b. Minimized multiplicity of complex models,
   c. A created appropriateness for considering subjective characteristics when determining valuation
   d. The allowance of accurate valuations for hard-to-value assets and allowance for financing where obtaining financing is traditionally very difficult.
d) Restricting the number of valuations received allows for the advantages of:
   a. Motivated evaluators towards timeliness
   b. earlier turnarounds on valuation requests
   c. reduced costs, as only the first individuals willing to accept the rate and who provide the service are included in the competition

Other Objects and Advantages are:
e) Potential for greater market orientation and ability to adapt to the market as older complex and lethargic systems are excluded if they are less accurate
f) Potential for higher values on securities (stocks or bonds) associated with the assets being valued, as their equity position or liability position is uncovered in a more clearly substantiated way
g) Potential for mitigating asset bubbles as valuation professionals are not forced to comply with the current market “group think” and “undue pressure”, and are forced to be as accurate as possible

Still further objects and advantages will become apparent from a consideration of the ensuing description and flow chart.

### SUMMARY

This business method allows for the valuation of assets, liabilities, or other items which customers might pay to have a valuation of, in which the valuation estimates of multiple individuals or other sources are competing to provide a valuation estimate that is more median or closer to the average of the estimates than their competitors. They are competing because their compensation for the valuation is dependent on how close they are to the most accurate median number. This method may revolutionize a few otherwise bewildered valuation industries (Intellectual Property, Business Valuation, Real Estate Appraisal, Large Project bidding, ect . . . ) that are in need of a centralizing method.

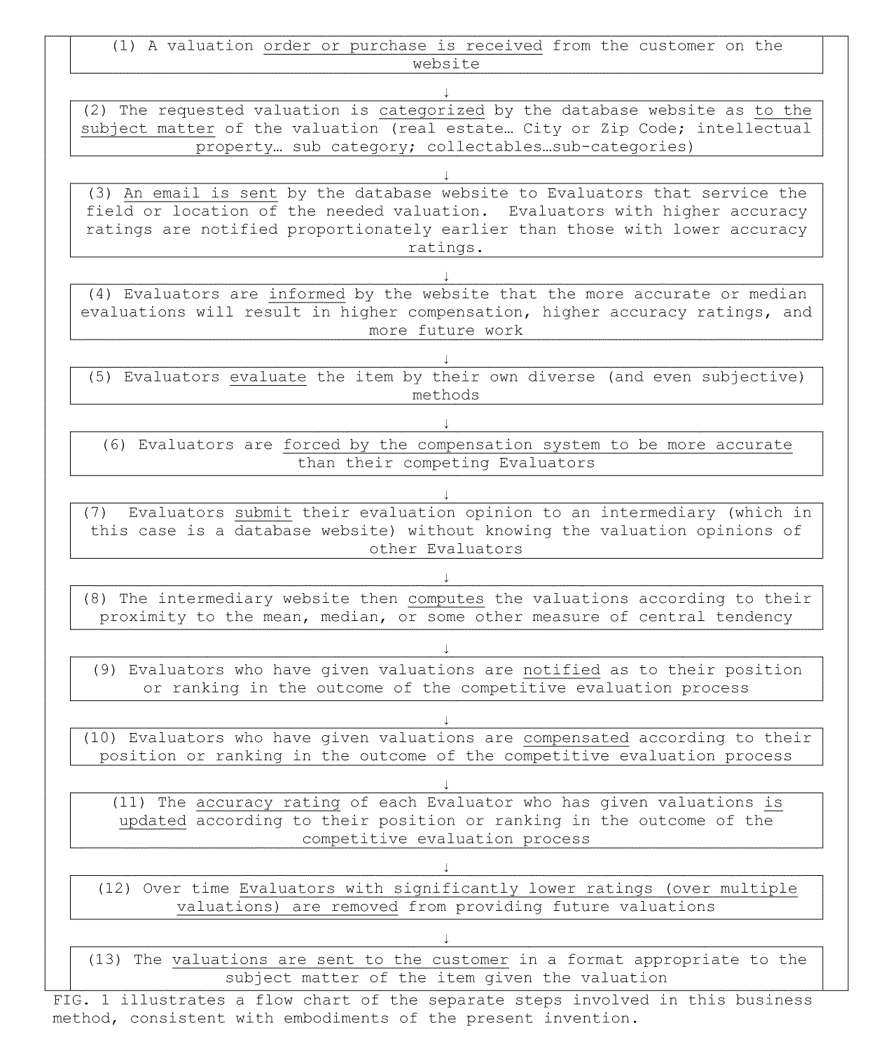

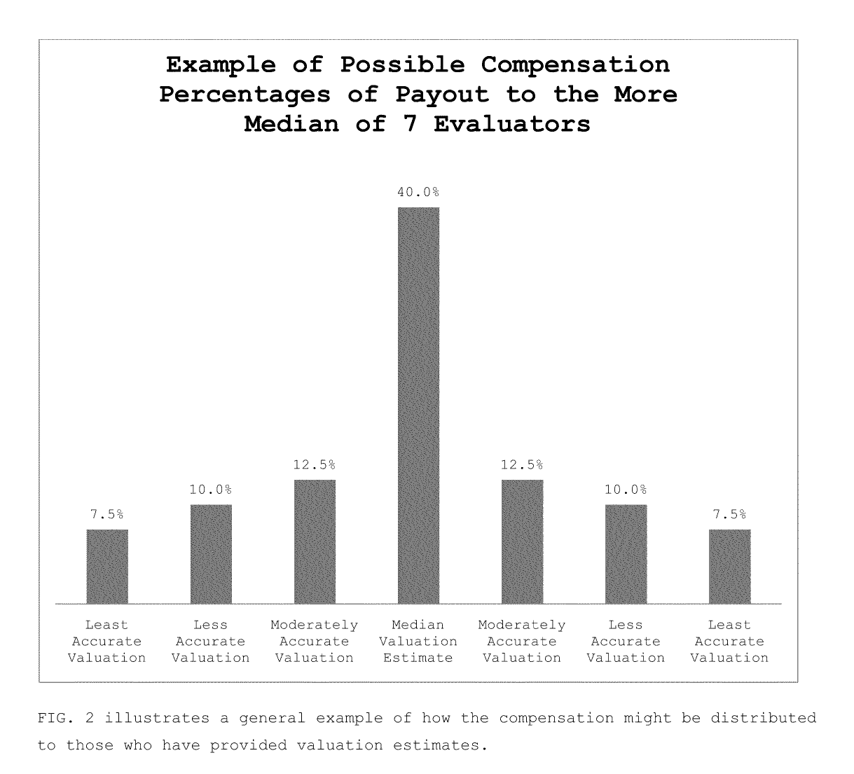

### DETAILED DESCRIPTION—FIGS. 1 and 2—PREFERRED EMBODIMENT

Reference will now be made in detail to embodiments of the invention, examples of which are illustrated in the FIGS. 1 and 2. Wherever possible, the same reference numbers for each step in the flow chart will refer to the steps in the business method.

FIG. 1 illustrates a flow chart of the separate steps involved in this business method, consistent with embodiments of the present invention.

Step (1) is the beginning of the process where a valuation order or purchase is received from the customer on a database website. The website has a user interface with secure log-on functions for Customers, Evaluators, and other users. This user interface website connects to a database which holds information associated with the users. This may include but is not limited to contact information, order details, logon information, payment information, accuracy ratings, and so on. The database may also be linked to an information providing platform which may supply information to the database regarding the item which is to be evaluated. For example if it is an order for the valuation of real estate, then it may be linked to information such as address, size, or tax parcel number. If the valuation order is for the valuation of Intellectual property, then database may be linked to information on the USPTO website, and so on.

In step (2) the requested valuation is categorized by the database website as to the subject matter of the valuation. For example if the subject matter is real estate valuation then real estate agents or appraisers in the zip code of that property might be denoted. If the subject matter is intellectual property, then the website database might also be set to match an appropriate subcategory and denote the professionals in that industry that should be notified.

In step (3) An email is sent by the database website to the Evaluators which were denoted in step (2) Some of those Evaluators will have higher ratings than others in accordance with their accuracy over past valuations that they have participated in. Within this step a function may be employed, wherein those Evaluators with higher accuracy ratings may be notified proportionately more promptly than those with lower accuracy ratings.

In step (4) Evaluators are informed of the competitive characteristic of the process, perhaps in the same email sent in step (3), that the more accurate valuations will result in higher compensation, and also higher accuracy ratings, and prompter notification future work. FIG. 2 illustrates this compensation in a general fashion. Notice that the most accurate valuation estimate is compensated with a considerably higher percent of the total compensation paid to Evaluators. Notice also that here there are seven Evaluators, but this is not meant to be a limiting characteristic, the number of evaluators must only be plural. Also, the compensation paid to the Evaluators may not always fit the percentages. They may range quite differently. Lastly, in cases with an even number of Evaluators, another measure of central tendency may be necessary such as proximity to the average of estimates, or other measures of central tendency.

In this email they may also be informed that only a limited number of valuations will be included in the competition for compensation. This notification is to induce promptness, and might not be included in every valuation competition.

In step (5) the Evaluators evaluate the item by their own diverse (and even subjective) methods. The method of Valuation may depend significantly on the industry or the subject matter of the item being valued. Part of the beauty of this system is that the final valuation number and the valuations that surround and support it are significantly supported as the “opinions of multiple competing professionals”. This multiple opinion scenario will likely alleviate some of the pressure to confine the valuation professional to a specific set of prescribed, recorded, and monotonous steps. As an aside, it is these steps which often make the process of valuing an asset time consuming and expensive, while not always providing a more accurate or timely valuation. Furthermore, if this alleviation is significant enough, then some latitude will be allowed for Evaluators to include more subjective characteristics in their valuation. This is an absolute necessity in many industries. In real estate for example, the idea of “street appeal” is only minimally observed in a traditionally prescribed appraisal process, but can significantly affect the salability of the property. In the intellectual property valuation industry the trends of technology are very difficult to put a number on, and even more difficult to justify in documentation. Removing the need for this documentation, by replacing it with the validity of “the professional opinions of multiple competing industry specialists” might alleviate some of that monotonous documentation pressure.

Step (6) is given a step number of its own to make it easy to denote. In step (6) Evaluators are forced by the compensation process to be more accurate than their competing Evaluators. This theory of forcing competition by compensation is one in which it seems logical to the inventor that accuracy, timeliness, and independence from undue influence can be induced through competition. More will be written on this forced competition process in the following “THEORY OF OPERATION” section.

In step (7) Evaluators log-on to the database website interface and submit their evaluation opinion without knowing the valuation opinions of other Evaluators. The Evaluators will be forced to be prompt in their timeliness because they will understand that only a limited number of valuations will be considered in the competition for compensation.

In step (8) the intermediary website then computes the valuations according to their proximity to the mean, median, or some other measure of central tendency. The website then denotes within the database the ranking outcomes of the competition and the compensation due to each Evaluator.

In step (9) Evaluators who have given valuations are notified as to their ranking in the outcome of the competitive evaluation process, and the compensation they will receive.

In step (10) Evaluators are compensated. Payment may be sent in a diversity of ways including but not limited to financial payments. Financial payments may occur by mailed check, direct deposit, or other means.

In step (11) the accuracy rating of each Evaluator is updated according to their position or ranking in the outcome of the competitive evaluation process. Those Evaluators who had valuations that were very accurate will see their scores increased, and those who were inaccurate will see their scores decreased. Accuracy is measured as proximity or distance to the median, mean, or some other measure of central tendency. The amounts that these accuracy scores will be adjusted will follow a preset schedule or mathematical function. The accuracy score may employ a weighted average, summation, or another method. It may be based on the sum of proximities to final valuations, rankings of the competitions, or other determining factors.

Step (12) denotes the characteristic of the process wherein over multiple valuation competitions the Evaluators with significantly lower ratings are notified of future valuation requests in a more and more delayed fashion. Continued inaccuracy will conclude in the removal of the Evaluator from providing future valuations. In this way the process will naturally select those Evaluators who are more accurate over multiple valuations.

In the final step, step (13), the valuations, which include the median valuation and supporting valuations are sent to the customer. They are sent to the customer in a format appropriate to the subject matter of the item given the valuation. For example, in real estate valuations the format may look much like a standard appraisal document, and so forth for other industries.

### Theory of Operation

This idea first came to me while working as a real estate agent and meeting with a client to communicate the value of his property. I was competing with another agent for the listing. I believed the home was worth $215,000 and was most likely to sell at that price, and I expressed that the client.

A day or two later I received a call from the client wherein the I was told that the competing agent, after hearing my value estimate, felt that he could sell the home for $10,000 more than my estimate. The client asked if I felt I could beat that number. I was stuck because I had been as accurate as possible in the first place, while the other agent was just trying to sell the client on his services, and the client couldn't clearly see between our motivations.

After getting off the phone I realized that this home would be significantly over priced on the market, and likely would not sell until the price was reduced. This would cost the client time, and about $45/day in mortgage, tax, and utility fees while waiting for the home to sell. While pondering how the process could have been done better it occurred to me that the client should have received another bid; three blind bids in total, and then told the agents that the listing would be offered to the agent with the middle or median value estimate. In this way, the agents would be forced to accurate. That is when the idea was born. While discussing this with my wife later, I realized that the same process could be used for valuing many different types of assets or liabilities.

The theory behind this idea is that further accuracy, perhaps greater timeliness, and independence from undue influence could be induced in valuations by incentivizing Evaluators to be more median or average in their estimates than their competition, by compensating them to compete toward accuracy. Furthermore, those other skewing factors could be mitigated by isolating the proposed purpose of the competition. Where other purposes might be, “who can sell the asset for more?”, or “who might be best to hire for this construction, estimate, or sales process?” this system would specifically ask, “what is the market value of this asset or liability, while isolating from measurements of other factors or characteristics?” However, while I believe these properties of accuracy, timeliness, independence, and perhaps other benefits, emerge from this process, I do not wish this patent to be bound by the correctness or incorrectness of the theory.

Over time this theory may be established as more or less accurate, and more or less timely, than traditional valuation methods by charting the results of this theory and traditional methods on a 2-dimensional graph. A researcher could use timeliness as the horizontal axis and asset valuation as the vertical axis, then plot results from this method in one color and results from other methods in another color. Higher densities of the produced scatter-plots might indicate greater accuracy and denote the timeliness of different methods. This is one of many possible accuracy measurement processes.

Also, as a side note, “Evaluators”, as a term, means to me, any person participating in this process of providing valuations.

### Conclusion, Ramifications, and Scope

This Business method of a competitive valuation process has the potential to impact a number of industries which lack an appropriate centralizing and generally accepted valuation process. This process can be quickly understood as compared to the diversity of complex and bewildering valuation processes currently employed in a diversity of industries. This method also leaves room for those traditional valuation processes, and gives them a place to compete with other newer methods. This business method has the potential to positively affect real estate valuations, business valuations, intellectual property valuations, idea valuations, collectible valuations, the estimating of market trends, the valuing of commodities, the estimating of appropriate project costs for large projects, the estimating of liabilities and appropriate payouts in the insurance industry, the determining of risks or payouts in private insurance pools, and other significant markets niches.

Although the descriptions above contain specificities, these should not be construed as limiting the scope of the invention but as merely providing illustrations of some of the presently preferred embodiments of this invention. For example, the method could also be employed in a manual file system, in an in-house or intranet system, on desktop software, in other online software, in cloud software, in an online trading or auction site, or in other embodiments. Furthermore, other embodiments of the invention will be apparent to those skilled in the art from consideration of the specification and practice of the embodiments of the invention disclosed herein.

Thus the scope of the invention should be determined by the appended claims and the legal equivalents, rather than by the examples given.

### Other References

Webecke, Edmund. “360Value Streamlines Component-Based Replacement-Cost Estimation.” NationalUnderwriter/Property & Casualty Risk & Benefits Management 112.42 (2008): A18. MasterFILE Premier. EBSCO. Web. 22 Apr. 2010.
Hanford Jr., Lloyd D. “50+Years of Appraising.” Appraisal Journal 75.2 (2007): 166. MasterFILE Premier. EBSCO. Web. 22 Apr. 2010.
Finch, J. Howard, Travis L. Jones, and H. Shelton Weeks. “A Note for Appraisers on Option Valuation.” Appraisal Journal 76.3 (2008): 270. MasterFILE Premier. EBSCO. Web. 22 Apr. 2010.
“Agents, Brokers Urged to Correctly Assess Property Values.” Insurance Advocate 116.24 (2005): 30. MasterFILE Premier. EBSCO. Web. 22 Apr. 2010.
Nattagh, Nima, and David Ross. “An Updated Appraisal of Automated Valuation.” Mortgage Banking 61.2 (2000): 79. MasterFILE Premier. EBSCO. Web. 22 Apr. 2010.
“APPRAISAL APOPLEXY.” Kiplinger's Personal Finance 63.10 (2009): 16. MasterFILE Premier. EBSCO. Web. 22 Apr. 2010.
London, Gary. “Appraisers Going ‘Light’ on Home Values.” San Diego Business Journal 30.27 (2009): 39. MasterFILE Premier. EBSCO. Web. 22 Apr. 2010.
Goldwasser, Dan L. “BUSINESS VALUATION SERVICES.” CPA Journal 70.5 (2000): 14. MasterFILE Premier. EBSCO. Web. 22 Apr. 2010.
Rose, Chris, John Cronin, and Rachael Schwartz. “COMMUNICATING THE VALUE OF YOUR INTELLECTUAL PROPERTY TO WALL STREET.” Research Technology Management 50.2 (2007): 36. MasterFILE Premier. EBSCO. Web. 22 Apr. 2010.
Reynolds, Anthony. “Current Valuation Techniques: A Review.” Appraisal Journal 52.2 (1984): 183. MasterFILE Premier. EBSCO. Web. 22 Apr. 2010.
Wilkes, David C., and Steven A. Shapiro. “Detecting Intangible Asset Value (or Capitalized Economic Profit) in Sales to REITs: A Practical Framework for Analysis.” Real Estate Issues 29.4 (2004): 9. MasterFILE Premier. EBSCO. Web. 22 Apr. 2010.
Barney, Jonathan, and Cameron Gray. “Equities and Patents.” Equities 55.5 (2007): 8. MasterFILE Premier. EBSCO. Web. 22 Apr. 2010.
Kane, M. Steven, Mark R. Linné, and Jeffrey A. Johnson. “Evaluating the Valuers.” Appraisal Journal 72.2 (2004): 147. MasterFILE Premier. EBSCO. Web. 22 Apr. 2010.
“GMAC-RFC OFFERS NEW APPRAISAL ALTERNATIVE.” Mortgage Banking 64.11 (2004): 85. MasterFILE Premier. EBSCO. Web. 22 Apr. 2010.
Jarboe, Kenan Patrick, and Ian Ellis. “Intangible Assets: Innovative Financing for Innovation.” Issues in Science & Technology 26.2 (2010): 75. MasterFILE Premier. EBSCO. Web. 22 Apr. 2010.
Martin, Daryl, and David C. Drews. “Intellectual Property Valuation.” Secured Lender 61.5 (2005): 22. MasterFILE Premier. EBSCO. Web. 22 Apr. 2010.
“Liability and the Appraiser's Property Inspection.” Appraisal Journal 75.2 (2007): 109. MasterFILE Premier. EBSCO. Web. 22 Apr. 2010.
“NYAG, Fannie, Freddie, OFHEO agree to combat appraisal fraud.” Mortgage Banking 68.7 (2008): 10. MasterFILE Premier. EBSCO. Web. 22 Apr. 2010.
Palmeri, Christopher. “Real Estate Appraisers Face Big Changes.” BusinessWeek Online (2009): 2. MasterFILE Premier. EBSCO. Web. 22 Apr. 2010.
Nattagh, Nima, and Dave Ross. “Refining Valuation Models.” Mortgage Banking 65.11 (2005): 70. MasterFILE Premier. EBSCO. Web. 22 Apr. 2010.
Abernethy, Avery M., and Harris Hollans. “The Home Valuation Code of Conduct and Its Potential Impacts.” Appraisal Journal 78.1 (2010): 81. MasterFILE Premier. EBSCO. Web. 22 Apr. 2010.
Waller, Bennie. “The Impact of AVMs on the Appraisal Industry.” Appraisal Journal 67.3 (1999): 287. MasterFILE Premier. EBSCO. Web. 22 Apr. 2010.
Young, Stephen B. “The search for moral capitalism and the Holy Grail of business valuation.” Ivey Business Journal 68.4 (2004): 1. MasterFILE Premier. EBSCO. Web. 22 Apr. 2010.
McWilliams, Charlyne H. “The Tale of AVMs.” Mortgage Banking 64.5 (2004): 80. MasterFILE Premier. EBSCO. Web. 22 Apr. 2010.
ROGERS, FRANCI. “the VALUE OF VALUATION.” Baylor Business Review 27.1 (2008): 24. MasterFILE Premier. EBSCO. Web. 22 Apr. 2010.
Nadeau, Stephen. “Underwrite, Don't Undervalue Property.” National Underwriter/Property & Casualty Risk & Benefits Management 113.37 (2009): 31. MasterFILE Premier. EBSCO. Web. 22 Apr. 2010.
Foster, Benjamin P., Robin Fletcher, and William D. Stout. “Valuing Intangible Assets.” CPA Journal 73.10 (2003): 50. MasterFILE Premier. EBSCO. Web. 22 Apr. 2010.
   Hollas, Daniel R., Ronald C. Rutherford, and Thomas A. Thomson. “Zillow's Estimates of Single-Family Housing Values.” Appraisal Journal 78.1 (2010): 26. MasterFILE Premier. EBSCO. Web. 22 Apr. 2010

What is claimed is:

1) A method of assessing the value, or range of values, of assets or liabilities, comprising the steps of:
(a) providing a plurality of sources of estimates,
(b) providing a plurality of said estimates of the said value of the said assets or said liabilities from said sources,
(c) investigating said estimates by means of said central tendency,
(d) rewarding the sources of said estimates according to proximity of said value estimates to said central tendency, and
(e) providing the said value, or said range of values, from said central tendency,
whereby said value of said asset or said liability will be discovered with substantially greater accuracy.

2) The method of assessing the value, or range of values, of assets or liabilities, of claim 1 wherein said steps include means to allow the method to operate on computer software or the internet.

3) The method of assessing the value, or range of values, of assets or liabilities, of claim 1 wherein said sources of estimates are informed of this process of rewarding said source according to proximity from means of central tendency whereby they may be further motivated by competition toward greater accuracy.

4) The method of assessing the value, or range of values, of assets or liabilities, of claim 1 wherein said assets or said liabilities include but are not limited to the valuation of: real property, personal property, collectibles, currency, intangible property, intellectual property, businesses, opportunities, strengths, weaknesses, risks, financial securities, and other items of which a person may wish to know the value.

5) The method of assessing the value, or range of values, of assets or liabilities, of claim 1 wherein said sources of estimates include but are not limited to: individuals, professionals, the general public, means of valuation that are known to others, automated methods of estimating value, neural networks, expert systems, knowledge based systems, generally accepted accounting principles, accounting based valuations systems, sales approaches, cost approaches, hedonic approaches, repeat sales approaches, objective approaches, subjective approaches, hybrid approaches, and appraisal systems.

6) The method of assessing the value, or range of values, of assets or liabilities, of claim 1 wherein said means of central tendency include but are not limited to: the standard deviation, the average, the median, the mode, the range, and other means by which a central estimate of value or range of values may be discovered.

7) The method of assessing the value, or range of values, of assets or liabilities, of claim 1 wherein said rewarding may include, but are not limited to: financial payments, an improved accuracy rating, future valuation transactions, and other means.
